(19) United States
(12) Patent Application Publication
(10) Pub. No.: US 2010/0047613 A1
(43) Pub. Date: Feb. 25, 2010

(54) Advanced end fitting design for composite brace, strut, or link

(75) Inventor: Vincent T. Padden, Stuart, FL (US)

Correspondence Address: BODNER & O'ROURKE, LLP, 425 BROADHOLLOW ROAD, SUITE 108, MELVILLE, NY, 11747, US

(73) Assignee: Air Industries Group, Inc., Bay Shore, NY (US)

(21) Appl. No.: 12/583,360

(22) Filed: Aug. 19, 2009

Related U.S. Application Data
(60) Provisional application No. 61/189,436, filed on Aug. 19, 2008.

(51) Int. Cl. B32B 3/00; B32B 15/00; B32B 38/00

(52) U.S. Cl. 428/614; 428/189; 156/263

(57) ABSTRACT

A composite brace, strut, or link for any application requiring the transfer of a concentrated load uses a stepped insert at the lug end to distribute the applied loads into a composite structure formed of a stacked arrangement of internal and external plies of composite material. The manufacture of the brace, strut, or link is performed in a cost effective manner. The composite lay-up is done so that many individual parts can be cut from the initial multi-part assembly, allowing the economy of scale to lower fabrication costs of the individual manufactured parts. The structure provides a system whereby the concentrated load applied at the stepped inserts can be distributed into the composite material without any gapping or separation as would occur in a traditionally configured end fitting joint between a circular metallic bushing and the adjacent composite material interface.

### CROSS REFERENCE TO RELATED APPLICATION

This application is based on U.S. Provisional Application No. 61/189,436, filed on Aug. 19, 2008, and entitled, “Advanced End Fitting Design for Composite Brace, Strut, or Link”, the disclosure of which is incorporated herein by reference and on which priority is hereby claimed.

### FIELD OF THE INVENTION

The present invention relates to an advanced composite structure and manufacture of same. More particularly, the present disclosure relates to structure wherein a concentrated load can be efficiently transferred into and out of the composite structure.

### BACKGROUND OF THE INVENTION

There are many situations where a brace, strut, or link type structure is required for joining two adjacent structures or components to transfer a concentrated load between two points. The materials used in these applications have traditionally been metallic. Typically, these links have been machined, forged or cast. However, a metal link has a weight disadvantage when compared to a reinforced plastic composite link of equal function. Metal weighs substantially more than a comparative reinforced plastic composite structure.

Historically, the cost associated with the manufacture of composite structures has been a concern in determining their use. Technological advances have decreased the cost associated with the manufacturing of composites and have made composite structures more competitive.

The use of composite materials in aircraft primary structure has become widely accepted in the aircraft industry. Substantial weight savings have been achieved. For structures such as braces, struts, and links where concentrated loads are introduced at a single location on each end, the load transfer using composite materials has presented a significant issue for designers.

### OBJECTS AND SUMMARY OF THE INVENTION

An object of the present disclosure is to provide structure whereby concentrated loads can be efficiently transferred into a composite material without compromising the ability of the composite material to perform load transfer at the interface between the point of load application and the composite material.

Another object of the present invention is to provide a brace at least partially formed from a composite material and end fittings in which a load placed on the end fittings may be efficiently transferred to the composite material.

A further object of the present invention is to provide a composite brace, strut, link or other structure which is comparatively light weight yet strong to handle relatively high concentrated loads.

Yet a further object of the present invention is to provide a method for manufacturing a composite brace.

A still further object of the present invention is to provide a composite brace, strut or link which overcomes the inherent disadvantages of conventional metallic braces, struts and links.

The present disclosure is intended to provide structure that incorporates an efficient method of transferring a concentrated load into a composite strut, brace, or link (collectively referred to herein as “brace”) by using a tailored or stepped insert. More specifically, a brace formed in accordance with the present invention includes one or more end fittings or inserts, which are preferably formed of a metallic material, and an intermediary or secondary structure formed from a composite material which is joined to the one or more end fittings. Each end fitting preferably has at least one outer surface which is stepped. The composite material structure engages the stepped surface of the end fitting and is joined thereto such as by bonding the metallic end fitting to the composite material. Preferably, the composite material may be formed from plies, preferably one ply resting on and engaging a corresponding step of the stepped end fitting or insert. The stepped end fitting or insert allows the introduction of both tensile and compressive loads in a manner that distributes the load uniformly to the composite material without overloading the bond between the metal end fitting and the composite material. The stepped end fitting is configured to transfer the load into the composite structure, while maintaining strain compatibility between the composite material and the stepped insert for both tensile and compressive loads. The configuration provides a method by which gapping between the metallic bushing and the composite material in a traditionally configured joint under axial loads, and the resultant failure of the composite matrix, can be avoided.

The configuration of the stepped insert can be tailored to optimize the load transfer between the stepped insert and the composite structure to achieve maximum efficiency of load transfer. The unique “stepped” interface between the composite structure and the end fitting is optimized for each specific use. This structure can be applied to various composite strut, brace, and link cross-sections including among others: circular tubes, “I” sections, and various solid shapes.

Of particular concern in fabricating the metal and composite matrix (e.g., the overall brace) is the cost of the composite material and the processes involved in the lay-up of the composite material. The cost of hand lay-up can be lowered by utilizing automated processes for both cutting and lay-up of the composite material in the assembly process. Using automated processes and other cost effective fabrication methods result in an affordable weight efficient product.

The composite material can be laser cut into large sheets for use on a multiple strut assembly, and the stepped insert may be extruded in a single long length for use in a multiple strut assembly. The extruded length of stepped inserts may then be placed in a tool for holding in a precise position. The composite sheets may then be placed in the tool with the stepped inserts. The multiple strut assembly may then be cured and rough-cut into multiple individual braces. As a final step, the individual struts may have a final machining to remove unnecessary material.

These and other objects, features and advantages of the present invention will be apparent from the following detailed description of illustrative embodiments thereof, which is to be read in connection with the accompanying drawings.

### BRIEF DESCRIPTION OF THE DRAWINGS

The accompanying drawings, which are incorporated in and constitute a part of this specification, illustrate embodiments of the disclosure, and together with a general description of the disclosure given above, and the detailed description of the embodiments given below, serve to explain the principles of the present invention.

FIG. 1 is an exploded perspective view of a portion of a composite brace formed in accordance with the principles of the present invention and illustrating how the center core plies are mountable on the stepped insert of the composite brace.

FIG. 2A is a partially exploded perspective view of a portion of the composite brace of the present invention shown in FIG. 1 and illustrating how the external plies of the composite brace are mountable on the stepped insert and center core plies.

FIG. 2B is a perspective view of a portion of the assembled composite brace formed in accordance with the present invention.

FIG. 3A is a perspective view of another embodiment of the composite brace formed in accordance with the present invention.

FIG. 3B is a perspective view of yet another embodiment of the composite brace formed in accordance with the present invention.

FIG. 3C is a cross-sectional view of the composite brace shown in FIG. 3B taken along line 3C-3C of FIG. 3B.

FIG. 3D is a cross-sectional view of the composite brace shown in FIG. 3B taken along line 3D-3D of FIG. 3B.

FIG. 3E is an exploded perspective view of portions of the composite brace shown in FIG. 3B and cut along line 3C-3C of FIG. 3B.

FIG. 3F is a perspective view of a bottom longitudinal portion of the composite brace of the present invention shown in FIG. 3B and cut along line 3D-3D of FIG. 3B.

FIG. 3G is an exploded perspective view of an internal or external ply used in forming the composite brace of the present invention.

FIG. 4 is a perspective view of a stepped insert formed in accordance with the principles of the present invention.

FIG. 5 is a perspective view of a composite brace assembly blank formed of external plies, stepped inserts and center core plies before cutting and final machining to form multiple composite brace in accordance with the principles of the present invention.

FIG. 6A is a top view of the composite brace assembly blank of the present invention shown in FIG. 5 from which multiple composite braces are formed in accordance with the principles of the present invention.

FIG. 6B is a side view of the composite brace assembly blank of the present invention shown in FIGS. 5 and 6A from which multiple composite braces are formed in accordance with the principles of the present invention.

### DETAILED DESCRIPTION OF THE PREFERRED EMBODIMENTS

The composite laminate structure of the present invention provides an inexpensive lightweight brace for use in mechanical assemblies. Moreover, by providing a lightweight structure, the operating costs associated with the aircraft are decreased.

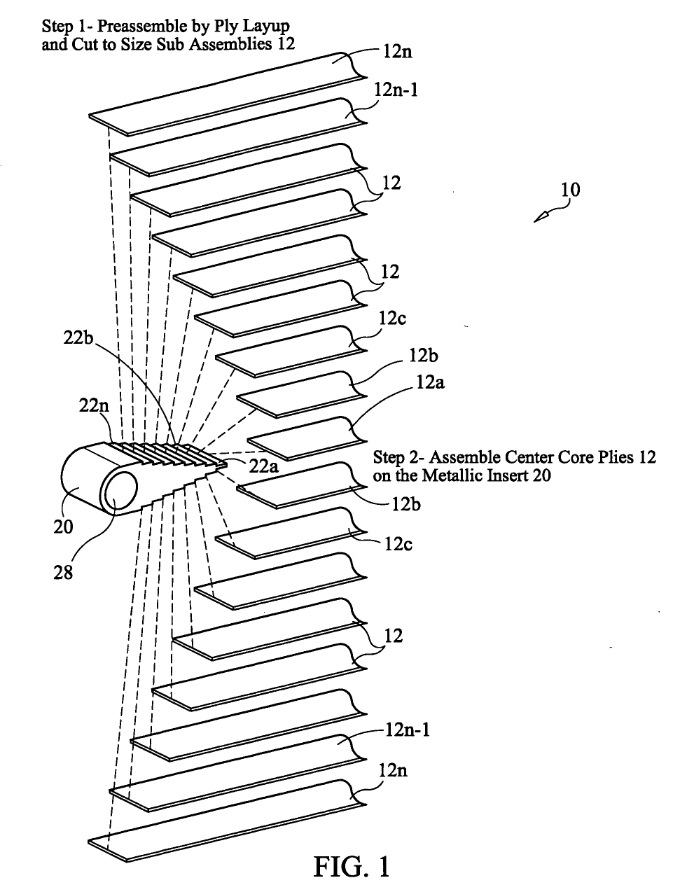

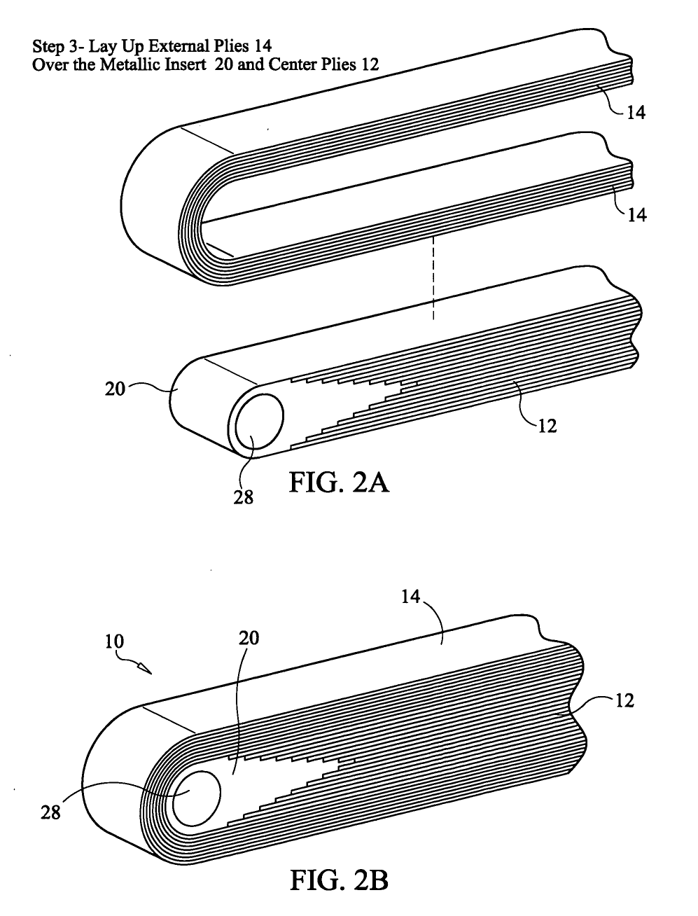

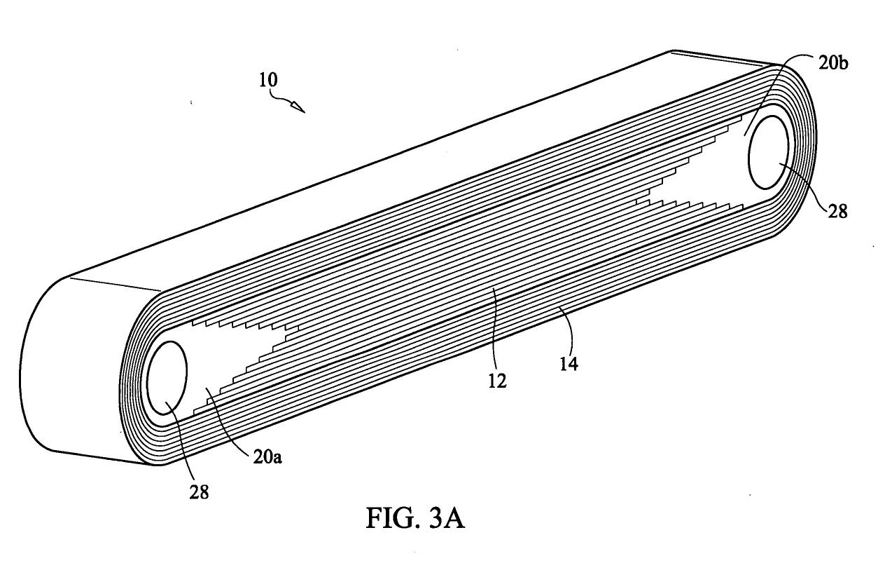

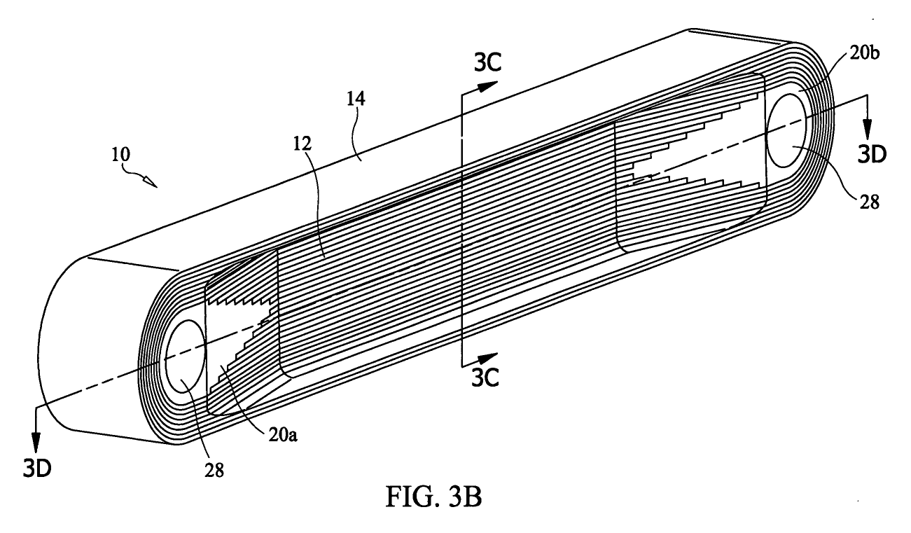

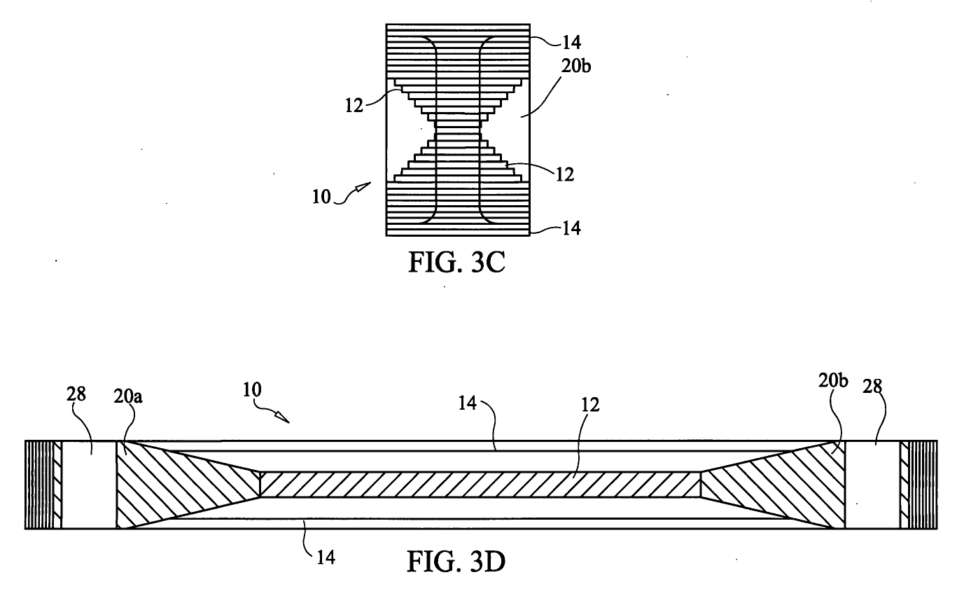

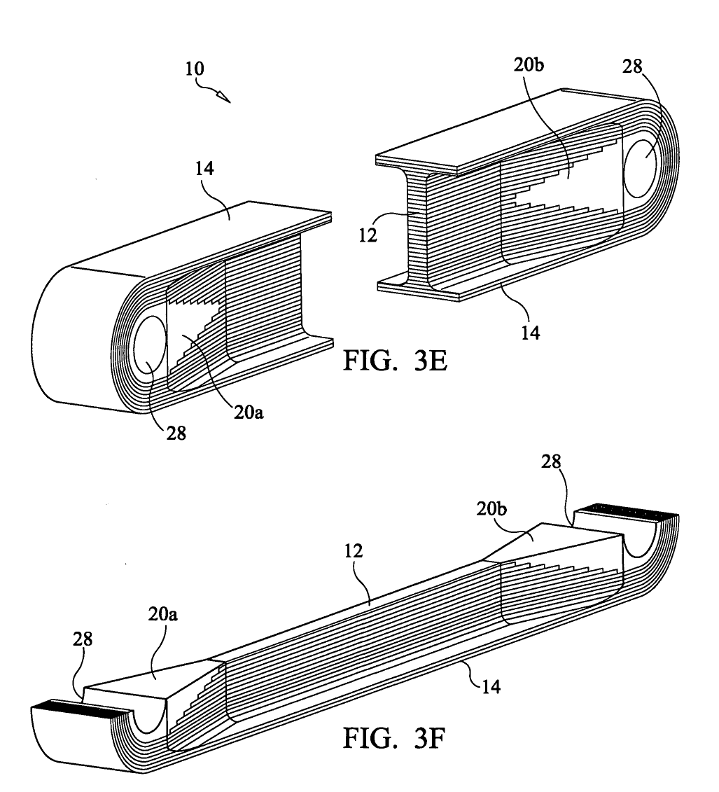

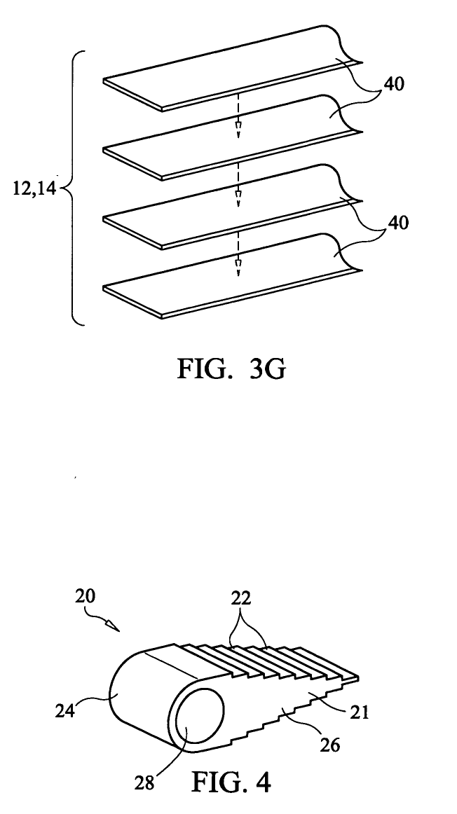

Reference is now made to the drawings, in which like reference numerals identify identical or substantially similar parts throughout the several views. A single brace, link, or strut 10 is illustrated in FIGS. 1-4 in accordance with one embodiment of the present disclosure. The brace 10 formed in accordance with the present invention comprises a series of flat inner composite plies 12 and at least one but preferably two stepped inserts 20 overlaid with another series of flat outer composite plies 14. Each of the composite plies 12, 14 is preferably a subassembly of a plurality of individual ply layers 40 joined together, as shown in FIG. 3G.

A stepped insert 20 for use in an axially loadable, composite laminated structure is illustrated in FIG. 4. A series of graded steps 22 preferably symmetrically projecting from each opposite side of the main body 21 of the stepped insert 20 is provided for the introduction of tensile and compressive loads in a controlled fashion to the body of the composite structure. The height of each step is preferably equal to the thickness of each inner composite ply assembly 12. A radiused (curved) outer portion 24 may define a side opposite the graded steps 22. A hole or bore 28 projects through the body 21 of the stepped insert 20 between lateral sides 26 and equidistant from the top and bottom sides having steps 22. The stepped insert 20 is symmetrical about the longitudinal plane. Each lateral side 26 of the stepped insert 20 is preferably, perpendicularly disposed to the longitudinal axis of the insert 20, but may be concavely shaped when the brace 10 is in its finished state to exhibit an “I” in transverse cross-section, as shown in FIGS. 3B and 3C.

The stepped insert 20 is preferably made of Titanium. One way to make a close tolerance stepped insert while minimizing cost is to extrude the stepped insert. A bushing (not shown) may be placed in the hole 28 of the stepped insert 20 to minimize wear on the hole 28 when a bolt, rod or other structure is received thereby. In addition, the steps 22 preferably protrude a greater distance horizontally (longitudinally) than the height of the steps (i.e., the run is greater than the rise).

With reference to FIGS. 3A-3F, a brace 10 with two stepped inserts 20a, 20b is illustrated. The body of the brace 10 comprises inner plies 12 of graphite epoxy laminate using a lay-up of graphite epoxy pre-pregnated tape, or other material. External plies 14 may be wrapped around the perimeter of the inner plies 12 and stepped inserts 20a, 20b to carry tensile forces into the body of the composite laminated structure. The series of composite plies 12, 14 may also be a laminate of graphite and epoxy pre-impregnated tape.

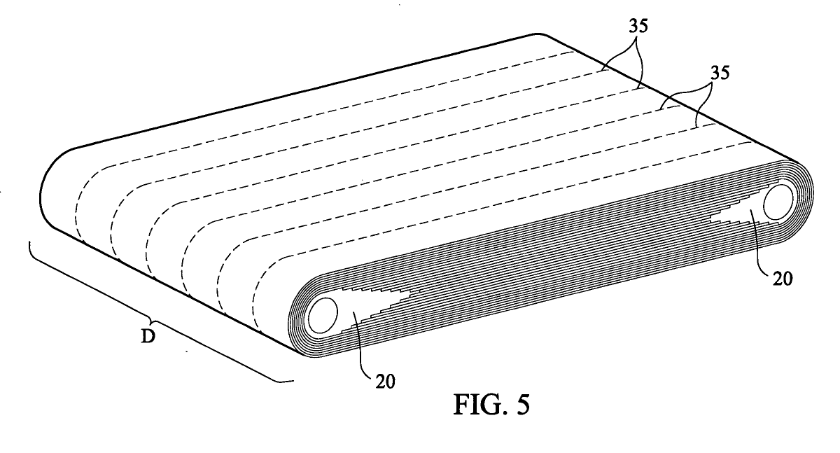

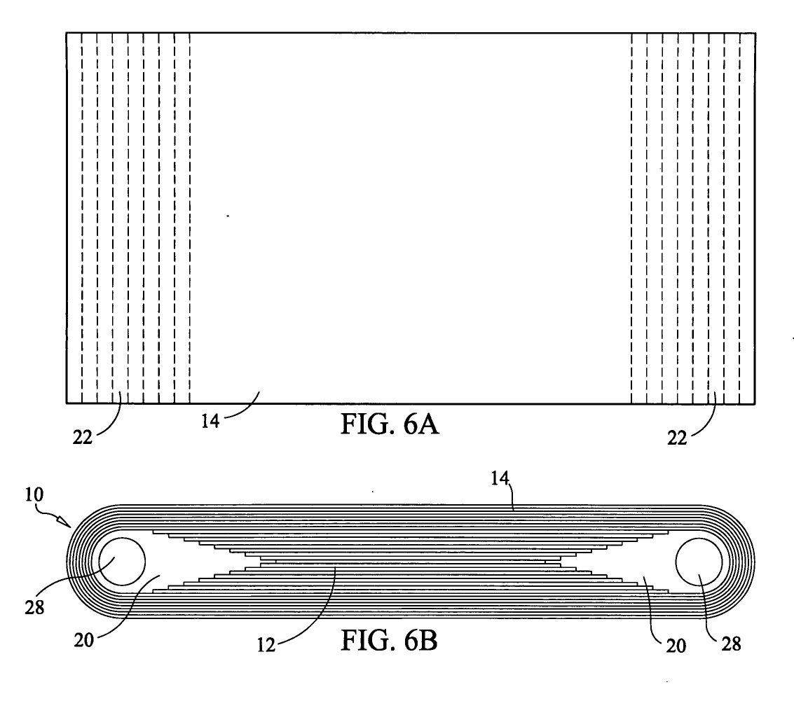

The center portion of the brace 10 is fabricated by cutting multiple preassembled plies and stacking the preassembled plies 12 from the part centerline to mate with each of the steps 22 on the stepped inserts 20a, 20b, at each end of the brace 10. This fabrication sequence is carried out with the aid of an assembly jig (not shown) in two stages. The outer external plies 14 are installed to complete the assembly using a lay-up of graphite epoxy pre-pregnated tape. To reduce costs further, the above assembly process is performed to create a wide section assembly consisting of many individual braces 10, as shown in FIGS. 5, 6A and 6B.

The steps to creating many individual braces in an efficient, cost effective manner are as follows and as shown in FIGS. 1, 2, 3A-3F, 5, 6A and 6B.

First, a series of composite plies 12 having the same width are cut into various lengths. Second, the stepped inserts 20a, 20b are placed into each end of a tooling fixture or assembly jig so that the stepped ends of the inserts 20a, 20b face one another. Third, the shortest of the series of composite plies 12a is placed between the stepped inserts 20a, 20b and in alignment with the most longitudinal extended stepped ends of inserts 20a, 20b. As further described below, one side of the composite brace 10 (e.g., the top side) is assembled first, and then the second side (e.g., the bottom side) is assembled. Alternatively, both the top and bottom sides of the composite brace 10 may be assembled simultaneously. Fourth, the next shortest of the series of composite plies 12b is placed over each of the initial (first) top steps 22a of the stepped inserts 20a, 20b so that the longitudinal end portions of the ply 12b rest on and engage the surface of the corresponding first top steps 22a, while the middle portion of the ply 12b rests on and engages the corresponding top surface of the first ply 12a. Fifth, the next (third) shortest of the series of composite plies 12c is placed over each of the next (second) top steps 22b of the stepped inserts 20a, 20b so that the opposite longitudinal end portions of the ply 12c rest on and engage the surfaces of the corresponding second top steps 22b, while the middle portion of the ply 12c rests on and engages the outer surface of the second ply 12b. This step is repeated until the longest of the series of composite plies 12n is placed over the second most top ply 12n-1 below it and so that the opposite longitudinal end portions of the top ply 12n rest on and engage the surfaces of the corresponding highest top steps 22n. Sixth, the tooling fixture is rotated so that the bottom of the composite brace 10 may be assembled by repeating the fourth and fifth steps described previously for assembly of the top side of the composite brace 10.

As mentioned previously, the top and bottom sections of the composite brace 10 may be assembled simultaneously. In such a manner, after the shortest of the series of composite plies 12a is placed between the stepped inserts 20a, 20b, then two equi-length, next shortest of the series of composite plies 12b are placed over each of the initial (first) steps 22a of the stepped inserts 20a, 20b so that the opposite longitudinal end portions of the plies 12b rest on and engage the surface of the corresponding first steps 22a, while the middle portions of the plies 22b rest on and engage the corresponding opposite top and bottom surfaces of the first ply 12a. Then, two equi-length, next shortest of the series of composite plies 12c are placed over each of the next (second) top and bottom steps 22b of the stepped inserts 20a, 20b so that the opposite longitudinal end portions of the plies 12c rest on and engage the surfaces of the corresponding top and bottom second steps 22b, while the middle portions of the plies 12c rest on and engage corresponding outer surfaces of the second top and bottom plies 22b. This step is repeated until the two longest, equi-length plies 12n of the series of composite plies are placed over the top and bottom plies 12n-1 directly below it and so that the opposite longitudinal end portions of the top and bottom plies 12n rest on and engage the surfaces of the corresponding top and bottom highest steps 22n of the stepped inserts 20a, 20b, while the middle portions of the plies 12n rest on and engage the corresponding outer surfaces of the top and bottom plies 12n-1 directly below it.

Seventh, a series of external plies 14 are placed around the inner plies 12 and stepped inserts 20a, 20b.

Eighth, the composite laminated structure is vacuum bagged and cured. After being bagged and cured, the part is cut (see cut lines 35 in FIG. 5) in depth D into smaller sections to form multiple individual braces 10. Then, the individual braces 10 preferably undergo a finish machining to provide at least the middle portion of each composite brace 10 with an “I”-shaped cross-section and to complete the part. Finish cutting of the cured inner composite plies 12 and stepped inserts 20a, 20b is done to taper the width of the cured composite plies 12 and/or stepped inserts 20a, 20b toward the middle of the structure, such that the stepped inserts 20a, 20b and composite inner plies 12 and possibly outer plies 14 are wider at the ends than at the center. The tapering of the center section as shown in FIGS. 3B-3F is preferably done to reduce weight.

FIGS. 5, 6A and 6B illustrate the brace assembly blank before it is cut into several braces. The inner plies 12 (also referred to collectively as the “core ply assembly”) are sandwiched between and surrounded by the external plies 14 (also referred to collectively as the “external ply assembly”), with the stepped inserts 20a, 20b positioned at opposite axial ends of the inner plies 12 and also sandwiched between and surrounded by the external plies 14. The blank may be 12 inches in width, for example, and 12 inches in length measured between the centers of insert holes 28, for example, as shown in FIG. 5.

As will be appreciated from the detailed explanation provided below, the transfer of concentrated loads into the composite brace 10 can be successfully achieved without compromising the limitations of the composite plies 12, 14 at the stepped insert 20 interface with the adjacent attachment structure by using steps 22. The brace described above and shown in one or more of the figures has been analyzed to be lighter than and as strong as an equivalently-sized aluminum brace.

The distribution of load between the stepped insert 20 and the external plies 14 is dependent on the ratio of the Area×Modulus of Elasticity (AE) of the inner plies 12 and the Area×Modulus of Elasticity (AE) of the stepped insert 20 at the net section (A-A) (see FIG. 3). The balanced load distribution is obtained by consideration of the load transfer capability of the plurality of steps 22 of the stepped insert 20 where the load in the stepped insert 20 is transferred to the inner plies 12. This iterative process is used to obtain the optimum configuration defining the number and size of steps 22, the thickness of the stepped insert 20 at the net section and the number of external plies 14. The optimized configuration results in the efficient transfer of load with no gapping between the stepped insert 20 and the composite plies 12, 14, thus maintaining joint integrity.

Preferably, each step 22 of inserts 20 has an exposed surface used to introduce axial compressive loads to the inner plies 12 and by shear lag to the external plies 14. Again as with the tensile case, no gapping between the stepped insert 20 and the inner plies 12 will occur, thereby preserving joint integrity.

The use of the stepped insert 20 to efficiently transfer the concentrated load to the composite material 12, 14 is comparable generally in form to the material used for the lug of a conventional metallic end fitting and therefore no weight penalty is incurred as related to a conventional metal design. The weight advantage of the presently disclosed structure is primarily realized over the body of the brace or strut.

To reiterate what was disclosed previously, a composite brace 10 formed in accordance with the present invention includes at least one stepped insert 20, the at least one stepped insert 20 having an outer surface formed with a graded series of parallelly disposed steps 22; and a plurality of flat composite plies 12 formed of a composite material, each composite ply 12 having an outer surface and an axial end portion, the end portions of at least some of the composite plies 12 resting on and engaging corresponding steps 22 of the outer surface of the least one stepped insert 20, the plurality of flat composite plies 12, when mounted on the at least one stepped insert 20, overlying one another in a stacked arrangement. In a preferred form, the at least one stepped insert 20 is formed of a metallic material, such as Titanium. Furthermore, the at least one stepped insert 20 of the composite brace 10 includes a main body 21 having opposite lateral sides 26, and the main body 21 has formed therein a bore 28 passing therethrough between the two opposite lateral sides 26.

Even more preferably, each respective step 22 of the at least one stepped insert 20 has a predetermined height measured with respect to a next adjacent step. Furthermore, each composite ply 12 of the plurality of composite plies has a thickness which is at most equal to the predetermined height of each step of the at least one stepped insert 20.

In one form of the present invention, each composite ply 12, 14 of the plurality of composite plies is a subassembly of a plurality of individual ply layers 40 joined together. More specifically, each composite ply 12, 14 of the plurality of composite plies may be formed of a graphite epoxy laminate using a lay-up of graphite epoxy pre-pregnated tape.

In an even more preferred form of the present invention, the composite brace 10 includes a first stepped insert 20a and a second stepped insert 20b. The first and second stepped inserts 20a, 20b are spaced apart from each other. Each of the first and second stepped inserts 20a, 20b has an outer surface formed with a graded series of parallelly disposed steps 22. Furthermore, each step 22 has a predetermined height. The first and second stepped inserts 20a, 20b are spaced apart from each other and disposed with their stepped outer surfaces facing each other.

Also, the composite brace 10, in this alternative form, includes a plurality of inner, flat composite plies 12 formed of a composite material. Each inner composite ply 12 has an outer surface and opposite axial end portions. The end portions of at least some of the inner composite plies 12 rest on and engage corresponding steps 22 of the outer surfaces of the first and second stepped inserts 20a, 20b. The plurality of inner composite plies 12, when mounted on the first and second stepped inserts 20a, 20b, overlie one another in a stacked arrangement situated between the first and second stepped inserts 20a, 20b.

In an even more preferred form of the composite brace 10 described above, a plurality of outer, flat composite plies 14 formed of a composite material is included. The outer composite plies 14 are wrapped about at least a portion of each of the first and second stepped inserts 20a, 20b and overlie the inner composite plies 12 in a stacked arrangement.

The present invention also relates to the structure of an end fitting 20 for use in a composite brace 10. Such a composite brace 10 has a plurality of flat composite plies 12 formed of a composite material, where each composite ply 12 has an outer surface and an axial end portion, and a predetermined thickness. The end fitting 20 preferably includes a main body 21, the main body 21 having an outer surface, and a graded series of parallelly disposed steps 22 formed in the outer surface. Preferably, each step 22 resides in a plane, and each step 22 has an outer step surface which is engageable by the outer surface of an axial end portion of a respective composite ply 12 such that, when the axial end portions of the plurality of composite plies 12 engage the parallelly disposed steps 22 of the end fitting 20, the composite plies 12 overlie one another in a stacked arrangement.

Again, in a preferred form, the end fitting 20 is formed of a metallic material, such as Titanium.

In a preferred form, the main body 21 of the end fitting 20 includes opposite lateral sides 26, and the main body 21 has formed therein a bore 28 passing through between the two opposite lateral sides 26. Furthermore, each step 22 of the end fitting 20 preferably has a predetermined height on the outer surface of the end fitting measured with respect to a next adjacent step, the predetermined height being at most equal to the predetermined thickness of the composite plies 12. Stated another way, the plane in which each step 22 respectively resides is spaced from the plane in which a step 22 adjacent thereto resides by a predetermined distance, the predetermined distance being at most equal to the predetermined thickness of a composite plies 12.

As also described previously, a method of manufacturing a composite brace 10 in accordance with the present invention preferably includes the step of cutting a plurality of inner composite plies 12 each having the same width into various lengths, each of the cut inner composite plies 12 having opposite first and second axial end portions and being formed of a composite material. Then, a first stepped insert 20a and a second stepped insert 20b are spaced apart from one another a predetermined distance to define a spacing therebetween. Each of the first stepped insert 20a and the second stepped insert 20b has a main body 21, the main body 21 having a stepped outer surface and a graded series of parallelly disposed steps 22 formed in the stepped outer surface. Furthermore, each step 22 of each of the first stepped insert 20a and the second stepped insert 20b has an outer step surface, the first stepped insert 20a and the second stepped insert 20b being arranged with respect to each other such that the stepped outer surface of the first stepped insert 20a faces the stepped outer surface of the second stepped insert 20b.

The method of manufacturing the composite brace 10 further includes the step of placing the cut inner composite plies 12 having various lengths in alignment with the first stepped insert 20a and the second stepped insert 20b such that at least the first axial end portions of the cut inner composite plies 12 rest on and engage the outer step surfaces of respective steps 22 of the first stepped insert 20a and such that at least the second axial end portions of the cut inner composite plies 12 rest on and engage the outer step surfaces of respective steps 22 of the second stepped insert 20b. The cut inner composite plies 12, when placed on the first stepped insert 20a and the second stepped insert 20b, overlie one another in a stacked arrangement bridging the spacing between the first stepped insert 20a and the second stepped insert 20b.

A plurality of outer composite plies 14 each having the same width and the same width as the inner composite plies 12 is cut into various lengths, each of the outer composite plies 14 being formed of a composite material. The cut outer composite plies 14 are placed on the first stepped insert 20a and the second stepped insert 20b and the stacked arrangement of inner composite plies 12 such that the cut outer composite plies 14 at least partially wrap around the first stepped insert 20a and the second stepped insert 20b and overlie the stacked arrangement of cut inner composite plies 12. The cut outer composite plies 14, when placed on the first stepped insert 20a, the second stepped insert 20b and the stacked arrangement of cut inner composite plies 12, overlie one another in a stacked arrangement. The first and second stepped inserts 20a, 20b, the cut inner composite plies 12 and the cut outer composite plies 14 together define a composite laminated structure.

Then, in accordance with a preferred method of manufacturing a composite brace 10, the composite laminated structure is cured such that the cut inner composite plies 12 adhere to one another and to the first and second stepped inserts 20a, 20b and so that the cut outer composite plies 14 adhere to one another and to the first and second stepped inserts 20a, 20b to form a composite brace 10 having a middle section and opposite axial end sections.

To reduce the weight of the composite brace 10, the width of the composite brace may be tapered such that at least a portion of the middle section of the composite brace 10 is narrower in width than the opposite axial end sections of the composite brace.

Also, in accordance with a preferred method of manufacturing the composite brace 10, after curing the composite laminated structure, the composite laminated structure may be cut into smaller sections to form a plurality of smaller composite braces 10, each of the smaller composite braces having a middle section and opposite axial end sections. Again, the width of each smaller composite brace 10 may be tapered such that at least a portion of the middle section on each smaller composite brace is narrower in width than the opposite axial end sections of each smaller composite brace 10.

Although illustrative embodiments of the present invention have been described herein with reference to the accompanying drawings, it is to be understood that the invention is not limited to those precise embodiments and that various other changes and modifications may be effected herein by one skilled in the art without departing from the scope or spirit of the invention.

What is claimed is:

1. A composite brace, which comprises:
at least one stepped insert, the at least one stepped insert having an outer surface formed with a graded series of parallelly disposed steps; and
a plurality of flat composite plies formed of a composite material, each composite ply having an outer surface and an axial end portion, the end portions of at least some of the composite plies engaging corresponding steps of the outer surface of the least one stepped insert, the plurality of flat composite plies, when mounted on the at least one stepped insert, overlying one another in a stacked arrangement.

2. A composite brace as defined by claim 1, wherein the at least one stepped insert is formed of a metallic material.

3. A composite brace as defined by claim 2, wherein the at least one stepped insert is formed of Titanium.

4. A composite brace as defined by claim 1, wherein the at least one stepped insert includes a main body having opposite lateral sides; and wherein the main body has formed therein a bore passing therethrough between the two opposite lateral sides.

5. A composite brace as defined by claim 1, wherein each respective step of the at least one stepped insert has a predetermined height measured with respect to a next adjacent step; and wherein each composite ply of the plurality of composite plies has a thickness which is at most equal to the predetermined height of each step of the at least one stepped insert.

6. A composite brace as defined by claim 1, wherein each composite ply of the plurality of composite plies is a subassembly of a plurality of individual ply layers joined together.

7. A composite brace as defined by claim 6, wherein each composite ply of the plurality of composite plies is formed of a graphite epoxy laminate using a lay-up of graphite epoxy pre-pregnated tape.

8. A composite brace, which comprises:
a first stepped insert and a second stepped insert, the first and second stepped inserts being spaced apart from each other, each of the first and second stepped inserts having an outer surface formed with a graded series of parallelly disposed steps, each step having a predetermined height, the first and second stepped inserts being spaced apart from each other and disposed with their stepped outer surfaces facing each other; and
a plurality of inner, flat composite plies formed of a composite material, each inner composite ply having opposite axial end portions, the end portions of at least some of the inner composite plies engaging corresponding steps of the outer surfaces of the first and second stepped inserts, the plurality of inner composite plies, when mounted on the first and second stepped inserts, overlie one another in a stacked arrangement situated between the first and second stepped inserts.

9. A composite brace as defined by claim 8, which further comprises:
a plurality of outer, flat composite plies formed of a composite material, the outer composite plies being wrapped about at least a portion of each of the first and second stepped inserts and overlying the inner composite plies in a stacked arrangement.

10. An end fitting for use in a composite brace, the composite brace having a plurality of flat composite plies formed of a composite material, each composite ply having an outer surface and an axial end portion and a predetermined thickness, the end fitting comprising:
a main body, the main body having an outer surface, and a graded series of parallelly disposed steps formed in the outer surface, each step residing in a plane, each step having an outer step surface which is engageable by the outer surface of an axial end portion of a respective composite ply such that, when the axial end portions of the plurality of composite plies engage the parallelly disposed steps of the end fitting, the composite plies overlie one another in a stacked arrangement.

11. An end fitting for use in a composite brace as defined by claim 10, wherein the end fitting is formed of a metallic material.

12. An end fitting for use in a composite brace as defined by claim 11, wherein the end fitting is formed of Titanium.

13. An end fitting for use in a composite brace as defined by claim 10, wherein the main body of the end fitting includes opposite lateral sides; and wherein the main body has formed therein a bore passing therethrough between the two opposite lateral sides.

14. An end fitting for use in a composite brace as defined by claim 10, wherein each step of the end fitting has a predetermined height on the outer surface of the end fitting measured with respect to a next adjacent step, the predetermined height being at most equal to the predetermined thickness of the composite plies.

15. An end fitting for use in a composite brace as defined by claim 10, wherein the plane in which each step respectively resides is spaced from the plane in which a step adjacent thereto resides by a predetermined distance, the predetermined distance being at most equal to the predetermined thickness of the composite plies.

16. A method of manufacturing a composite brace, which comprises the steps of:
cutting a plurality of inner composite plies each having the same width into various lengths, each of the cut inner composite plies having opposite first and second axial end portions and being formed of a composite material;
spacing a first stepped insert and a second stepped insert apart from one another a predetermined distance to define a spacing therebetween, each of the first stepped insert and the second stepped insert having a main body, the main body having a stepped outer surface and a graded series of parallelly disposed steps formed in the stepped outer surface, each step of each of the first stepped insert and the second stepped insert having an outer step surface, the first stepped insert and the second stepped insert being arranged with respect to each other such that the stepped outer surface of the first stepped insert faces the stepped outer surface of the second stepped insert;
placing the cut inner composite plies having various lengths in alignment with the first stepped insert and the second stepped insert such that at least the first axial end portions of the cut inner composite plies engage the outer step surfaces of respective steps of the first stepped insert and such that at least the second axial end portions of the cut inner composite plies engage the outer step surfaces of respective steps of the second stepped insert, the cut inner composite plies, when placed on the first stepped insert and the second stepped insert, overlie one another in a stacked arrangement bridging the spacing between the first stepped insert and the second stepped insert;
cutting a plurality of outer composite plies each having the same width and the same width as the inner composite plies into various lengths, each of the outer composite plies being formed of a composite material;
placing the cut outer composite plies on the first stepped insert and the second stepped insert and the stacked arrangement of inner composite plies such that the cut outer composite plies at least partially wrap around the first stepped insert and the second stepped insert and overlie the stacked arrangement of cut inner composite plies, the cut outer composite plies, when placed on the first stepped insert, the second stepped insert and the stacked arrangement of cut inner composite plies, overlie one another in a stacked arrangement, the first and second stepped inserts, the cut inner composite plies and the cut outer composite plies together defining a composite laminated structure; and
curing the composite laminated structure such that the cut inner composite plies adhere to one another and to the first and second stepped inserts and so that the cut outer composite plies adhere to one another and to the first and second stepped inserts to form a composite brace having a middle section and opposite axial end sections.

17. A method of manufacturing a composite brace as defined by claim 16, which further comprises the step of:
tapering the width of the composite brace such that at least a portion of the middle section of the composite brace is narrower in width than the opposite axial end sections of the composite brace.

18. A method of manufacturing a composite brace as defined by claim 16, which further comprises the step of:
after curing the composite laminated structure, cutting the composite laminated structure into smaller sections to form a plurality of smaller composite braces, each of the smaller composite braces having a middle section and opposite axial end sections.

19. A method of manufacturing a composite brace as defined by claim 18, which further comprises the step of:
tapering the width of each smaller composite brace such that at least a portion of the middle section on each smaller composite brace is narrower in width than the opposite axial end sections of each smaller composite brace.
